(19) United States
(12) Patent Application Publication
(10) Pub. No.: US 2011/0032925 A1
(43) Pub. Date: Feb. 10, 2011

(54) METHOD OF TRANSMITTING GROUP ACK/NACK IN A COMMUNICATION SYSTEM

(75) Inventors: Eun Jong Lee, Anyang-si (KR); Wook Bong Lee, Anyang-si (KR); Doo Hyun Sung, Anyang-si (KR); Suk Woo Lee, Anyang-si (KR); Hyung Ho Park, Anyang-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/922,560

(22) PCT Filed: Mar. 16, 2009
(86) PCT No.: PCT/KR09/01285

§ 371 Date: Oct. 25, 2010

Related U.S. Application Data
(60) Provisional application No. 61/037,311, filed on Mar. 17, 2008.

(30) Foreign Application Priority Data
Mar. 13, 2009 (KR) 10-2009-0021556

(51) Int. Cl. H04W 40/00

(52) U.S. Cl. 370/345

(57) ABSTRACT

The present invention relates to a wireless communication system, and more particularly, to a method of transmitting feedback, by which a signaling overhead can be efficiently reduced. In receiving a group feedback by a transmitting end in a wireless communication system, the present invention includes transmitting at least one data unit to a receiving end during a prescribed time interval and receiving a group feedback indicating a presence or non-presence of error for the overall at least one data unit from the receiving end. Accordingly, a transmitting/receiving end of a communication system transceives a group feedback for multiple feedbacks indicating an error presence or non-presence of overall data received in TTI, thereby reducing a signaling overhead.

### TECHNICAL FIELD

The present invention relates to a wireless communication system, and more particularly, to a method of transmitting feedback. Although the present invention is suitable for a wide scope of applications, it is particularly suitable for reducing a signaling overhead efficiently.

### BACKGROUND ART

Generally, an error control algorithm used for a wireless communication system can be mainly categorized into two kinds of schemes, ARQ (Automatic Repeat reQuest) and FEC (Forward Error Correction). The ARQ scheme includes Stop and Wait ARQ, Go-Back-N ARQ, Selective-Repeat ARQ, or the like. The Stop and Wait ARQ is the scheme for transmitting a frame, which is transmitted from a transmitting end to a receiving end each time, after checking a feedback (ACK signal) for a previous frame from the receiving end. And, the Go-Back-N ARQ is the scheme for retransmitting all data frames transmitted after an erroneous frame if error occurs in a receiving end as a result of transmitting N consecutive data frames from a transmitting end. Moreover, the Selective-Repeat ARQ is the scheme for selectively retransmitting only an erroneous frame to a receiving end from a transmitting end.

Compared to FEC, ARQ is more advantageous in that a structure of a receiver for error correction is much simpler than that of an FEC decoder. Moreover, a transmitting end using ARQ scheme retransmits an erroneous frame only, whereas a transmitting end using FEC scheme always sends redundancy for error correction. Therefore, ARQ scheme is more efficient than FEC scheme.

Yet, the conventional ARQ schemes have two major disadvantages as follows.

First of all, since a retransmission is performed in a radio link control (RLC) layer, a time delay may be increased.

Secondly, in the conventional ARQ, as a receiving end directly discards a packet which an error has occurred during an initial reception, it does not use any data contained in the initially received packet at all in case of receiving a retransmitted packet.

There is HARQ (hybrid-automatic repeat request) as an error control algorithm that further advances from the above ARQ. The HARQ is a scheme for controlling errors by combining ARQ and error correction and maximizing error correction capability of data received by retransmission. Namely, the HARQ is the scheme of hybridizing the conventional ARQ scheme of a MAC (Medium Access Control) layer and a channel coding scheme of a physical layer.

As representative examples of the HARQ schemes, there are Stop-and-Wait HARQ scheme and N-channel Stop-and-Wait HARQ scheme. In the following description, Stop-and-Wait HARQ scheme is explained with reference to FIG. 1.

First of all, Stop-and-Wait HARQ scheme is one of the simplest and efficient transmitting methods. Yet, transmission efficiency is degraded due to a rounding trip time (hereinafter abbreviated ‘RTT’) taken for a transmitting end Tx to receive a feedback signal, e.g., ACK (acknowledgement) or NACK (negative acknowledgement), from a receiving end Rx.

N-channel Stop-and-Wait HARQ scheme, which complements the above disadvantage, is explained with reference to FIG. 2 as follows.

Referring to FIG. 2, unlike Stop-and-Wait HARQ scheme, N-channel Stop-and-Wait HARQ scheme is a method for transmitting a different data frame during an RTT for a first data frame. Namely, several (N) independent Stop-and-Wait HARQ processes are operated until a feedback signal for the first data frame is exchanged. Generally, a receiving end in Stop-and-Wait HARQ scheme is able to check whether to succeed in receiving data through an error detection code such as CRC (Cyclic Redundancy Check).

If an error is not detected from a received data frame, a receiving end Rx transmits an ACK signal to a transmitting end. If an error is detected, the receiving end Rx transmits a NACK signal. Having received the ACK signal, the transmitting end Tx transmits next data. Having received the NACK signal, the data transmitting end Tx retransmits the corresponding erroneous data.

In this case, the transmitting end is able to change a format of the transmitted data according to a system. An example for this is explained with reference to FIG. 3 as follows.

Referring to FIG. 3, when a transmission bandwidth of a system is broad or data is transmitted/received using multi-antenna, a transmitting end is able to transmit a plurality of data transmission units during one transmission time interval (TTI). A receiving end receives the corresponding data and is then able to transmit m ACK/NACK signals for each of m data transmission units to the data transmitting end.

### DISCLOSURE OF THE INVENTION

### Technical Problem

However, as the number of data transmission units transmitted from a transmitting end during a time interval unit is incremented, resources for transmitting feedbacks from a receiving end to the transmitting end linearly increase to raise a signaling overhead of a control signal. Therefore, system efficiency is degraded.

Accordingly, the present invention is directed to a method of transmitting feedback that substantially obviates one or more of the problems due to limitations and disadvantages of the related art.

An object of the present invention is to provide a method of reducing a signaling overhead in transceiving a feedback signal.

### Technical Solution

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in receiving a feedback by a transmitting end in a wireless communication system, a method of receiving a group feedback for multiple feedbacks according to the present invention includes the steps of transmitting at least one data unit to a receiving end during a prescribed time interval and receiving a group feedback indicating a presence or non-presence of error for the overall at least one data unit from the receiving end.

Preferably, the group feedback includes a group ACK only if the transmitted at least one data unit is errorless overall. And, the group feedback comprises a group NACK if the transmitted at least one data unit is not errorless overall.

More preferably, the method further includes the step of if the group feedback comprises the group NACK, receiving feedback information indicating a presence or non-presence of error of each of the at least one data unit from the receiving end.

In this case, the group feedback is broadcasted from the receiving end via a sub-map of a prescribed subframe and the feedback information indicating the presence or non-presence of the error of the each of the at least one data unit is received via a prescribed resource block.

And, the group feedback receiving step includes the step of obtaining control information of the group feedback by blind-coding a control channel transmitted from the receiving end with a radio network temporary identifier (RNTI) for broadcasting information. In this case, the group feedback is obtained via a downlink shared channel using the control information.

Moreover, the feedback information indicating the presence or non-presence of the error of the each of the at least one data unit is obtained by decoding a PHICH (Physical HARQ Indication CHannel).

Besides, the radio network temporary identifier (RNTI) for the broadcasting information includes one of SI-RNTI, SC-RNTI, PI-RNTI and B-RNTI (Broadcast-RNTI) for the broadcasting information except system information.

Preferably, the transmitting end includes a terminal having multiple antennas and the at least one data unit is transmitted via at least one of the multiple antennas of the terminal.

To further achieve these and other advantages and in accordance with the purpose of the present invention, in transmitting a feedback by a receiving end in a wireless communication system, a method of transmitting a multiple feedback includes the steps of receiving a plurality of data units from a transmitting end during a prescribed time interval, detecting errors for a plurality of the received data units, respectively, and transmitting a group feedback indicating a presence or non-presence of error for a plurality of the overall data units to the transmitting end according to a result of the error detecting step.

Preferably, the group feedback includes a group ACK only if the received data units are errorless overall. The group feedback includes a group NACK if the received one data units are not errorless overall.

More preferably, if the group feedback includes the group ACK, the receiving end does not transmit feedback information on each of a plurality of the data units.

More preferably, the group feedback transmitting step includes the step of if the group feedback comprises the group NACK, transmitting feedback information indicating a presence or noon-presence of error of each of a plurality of the data units to the transmitting end.

In this case, the transmitting end includes a plurality of terminals, at least one of a plurality of the data blocks is transmitted by each of a plurality of the terminals, and the feedback information is only transmitted to the terminal having an error in a data unit among a plurality of the terminals.

Moreover, the group feedback is broadcasted to the transmitting end via a sub-map of a prescribed subframe and the feedback information is transmitted via a prescribed resource block within the subframe carrying the group feedback.

In this case, the group feedback transmitting step includes the steps of CRC masking control information of the group feedback with a radio network temporary identifier (RNTI) for broadcasting information and transmitting the control information to the transmitting end on a control channel.

And, the radio network temporary identifier (RNTI) for the broadcasting information includes one of SI-RNTI, SC-RNTI, PI-RNTI and B-RNTI (Broadcast-RNTI) for the broadcasting information except system information.

More preferably, the feedback information is CRC masked with a prescribed radio network temporary identifier (RNTI) value for the terminal having error in the data unit.

Preferably, the transmitting end includes a terminal having multiple antennas and a plurality of the data units are transmitted via at least one of the multiple antennas of the terminal.

It is to be understood that both the foregoing general description and the following detailed description are exemplary and explanatory and are intended to provide further explanation of the invention as claimed.

### ADVANTAGEOUS EFFECTS

Accordingly, the present invention provides the following effect or advantage.

A receiving end in a communication system transmits a group feedback for multiple feedbacks indicating a presence or non-presence of errors of whole data received in a transmission time interval unit, thereby reducing a signaling overhead.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a conceptional diagram for Stop-and-Wait HARQ;

FIG. 2 is a conceptional diagram for N-channel Stop-and-Wait HARQ;

FIG. 3 is a conceptional diagram for multiple HARQ feedback if a plurality of data transmission units are transmitted in one transmission time interval;

FIG. 4 is a diagram for examples of a group feedback available for a system having high probability of ACK occurrence according to one embodiment of the present invention;

FIG. 5 is a diagram for an example of applying the group feedback shown in FIG. 4 to a data transmission;

FIG. 6 is a diagram for examples of a group feedback available for a system having high probability of NACK occurrence according to one embodiment of the present invention;

FIG. 7 is a diagram for an example of applying the group feedback shown in FIG. 6 to a data transmission;

FIG. 8 is a conceptional diagram of a group feedback for data transmitted from a plurality of terminals according to another embodiment of the present invention;

FIG. 9 is a conceptional diagram of a group feedback for data transmitted from a terminal having a plurality of antennas according to another embodiment of the present invention; and

FIG. 10 is a diagram for an example of applying a group feedback to LTE communication system according to another embodiment of the present invention.

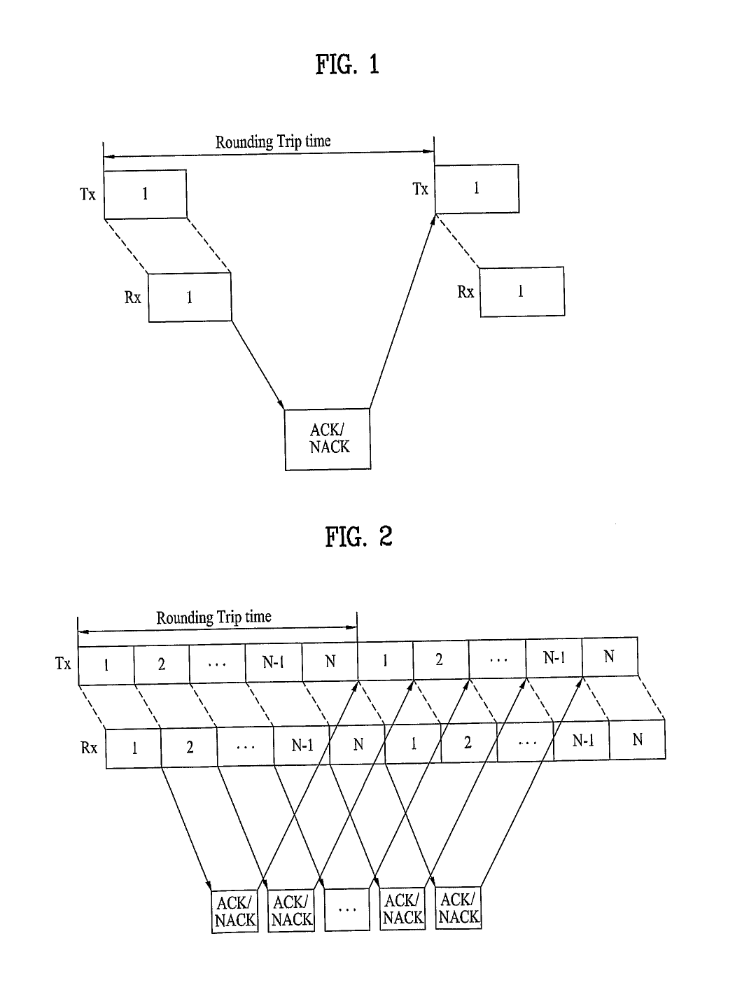

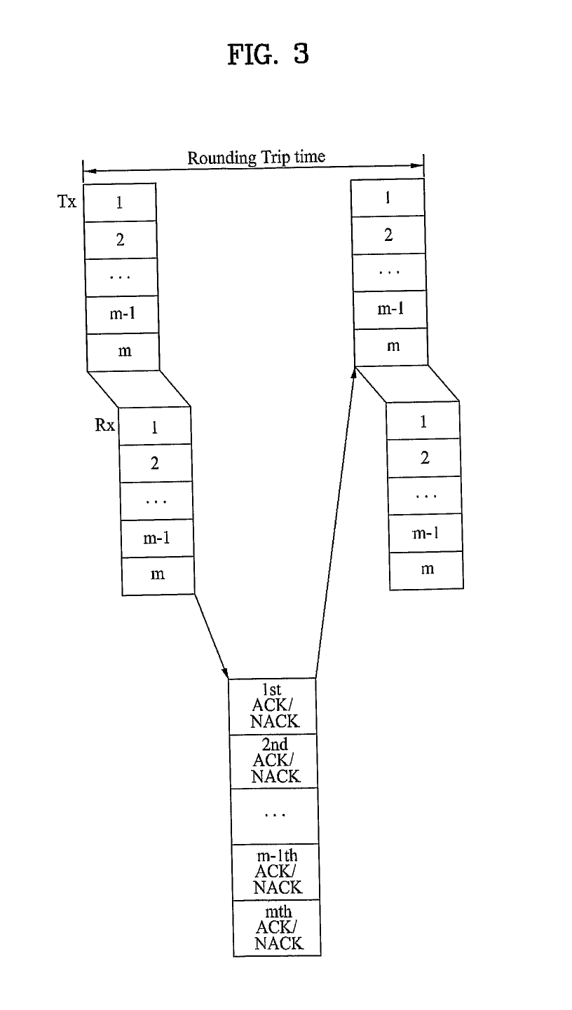

### MODE FOR INVENTION

Reference will now be made in detail to the preferred embodiments of the present invention, examples of which are illustrated in the accompanying drawings.

The present invention relates to a feedback method for a receiving end to inform a transmitting end of a presence or non-presence of erroneous data received received from the transmitting end in a communication system.

First of all, the following embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment.

In this disclosure, embodiments of the present invention are described centering on the data transmission/reception relations between a base station and a terminal. In this case, the base station is meaningful as a terminal node of a network which directly performs communication with the terminal. In this disclosure, a specific operation explained as performed by a base station can be performed by an upper node of the base station in some cases.

In particular, in a network constructed with a plurality of network nodes including a base station, it is apparent that various operations performed for communication with a terminal can be performed by a base station or other networks except the base station. In this case, ‘base station’ can be replaced by such a terminology as a fixed station, a Node B, an eNode B (eNB), an access point and the like. And, ‘terminal’ can be replaced by such a terminology as a user equipment (UE), a mobile station (MS), a mobile subscriber station (MSS) and the like.

Embodiments of the present invention can be implemented using various means. For instance, embodiments of the present invention can be implemented using hardware, firmware, software and/or any combinations thereof.

In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

In the following description, specific terminologies are provided to help the understanding of the present invention. And, the use of the specific terminology can be modified into another form within the scope of the technical idea of the present invention.

In this specification, for clarity, a data transmission unit for a receiving end to detect error via HARQ process or other feedback schemes and to make a request for a retransmission to a transmitting end is named ‘feedback process block’. Yet, in this specification, it is able to call the feedback process block ‘data block’ or ‘data unit’ for convenience of description.

In the present invention, if a transmitting end transmits a plurality of data blocks during a transmission time interval (hereinafter abbreviated ‘TTI’) or a plurality of feedback (ACK/NACK) signals are simultaneously transmitted to a receiving end, a method of reducing an overhead of a feedback signal is proposed.

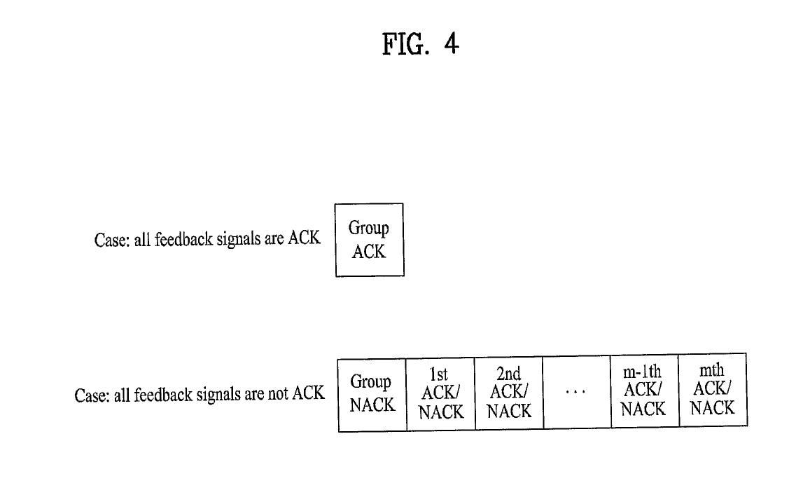

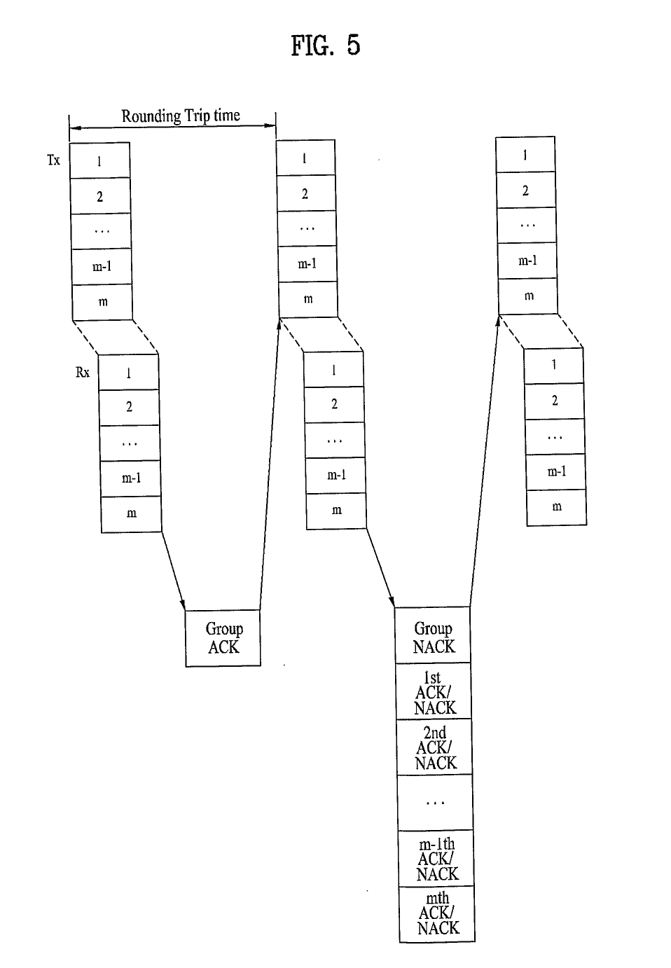

According to one embodiment of the present invention, a transmitting/receiving end is able to reduce feedback signals by considering success and failure probabilities of transmission data according to an environment of a communication system. For this, it is able to use a combination of group feedback, which indicates a presence or non-presence of error of every data block transmitted to a receiving end during a TTI, and feedback for each individual data block. This is explained with reference to FIGS. 4 to 7 in the following description.

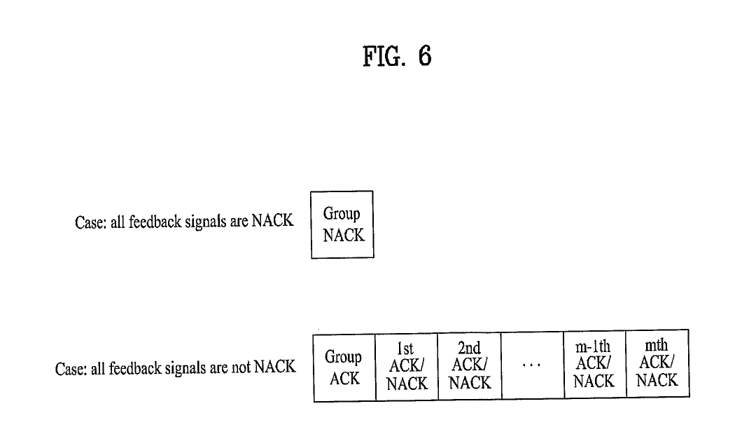

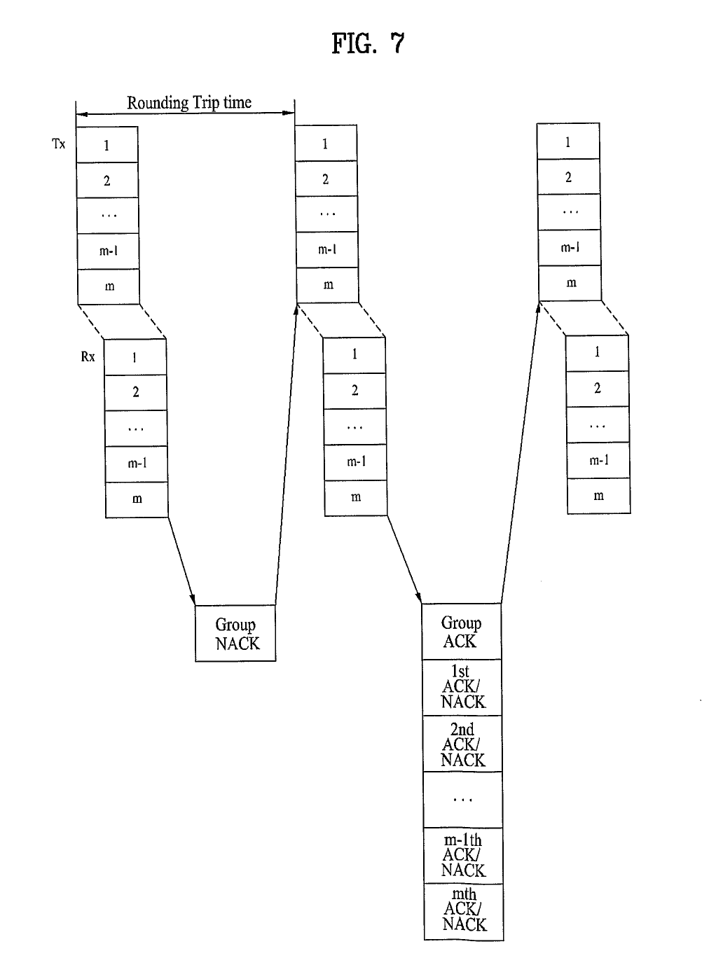

FIG. 4 shows examples of a group feedback available for a system having high probability of ACK occurrence according to one embodiment of the present invention, FIG. 5 shows an example of applying the group feedback shown in FIG. 4 to a data transmission. FIG. 6 shows examples of a group feedback available for a system having high probability of NACK occurrence according to one embodiment of the present invention, and FIG. 7 shows an example of applying the group feedback shown in FIG. 6 to a data transmission.

Referring to FIG. 4, when data transmission success probability is higher than data transmission failure probability, i.e., when a system has high probability of ACK occurrence, it is able to send a 1-bit ACK signal in case that all data blocks are ACK. If any one of the data blocks is erroneous, it is able to use a method of sending feedback (ACK/NACK) signals for each data block together with a group NACK signal. If this is applied to a data transmission, the structure shown in FIG. 5 can be provided.

On the contrary, if data transmission failure probability is higher than data transmission success probability, it is able to send a signal in a reverse form shown in FIG. 6. Namely, if all data blocks received by a receiving end is erroneous, the receiving end sends a 1-bit group NACK signal. If any one of the data blocks is errorless, the receiving end is able to send ACK/NACK signal for each data block to a transmitting end together with a group ACK signal. If this is applied to a data transmission, the structure shown in FIG. 7 can be provided.

If probability of successful transmission data varies in a system, it is able to adaptively operate the above-described two methods.

In the following description, effects in using the above methods are explained.

First of all, the bit number requested by a feedback signal in a system having high probability of ACK occurrence can be calculated by Formula 1.

N_{ACK/NACK}=p^{m}×1+(1−p^{m})×(m+1) [Formula 1]

In Formula 1, ‘p’ indicates transmission success probability of data block in a system and ‘m’ indicates the number of data blocks simultaneously transmitted during one TTI.

Secondly, the bit number requested by a feedback signal in a system having high probability of NACK occurrence can be calculated by Formula 2.

N_{ACK/NACK}=q^{m}×1+(1−q^{m})×(m+1) [Formula 2]

In Formula 2, ‘q’ indicates transmission failure probability of data block in a system and ‘m’ indicates the number of data blocks simultaneously transmitted during one TTI.

If a relation between the data block transmission success probability calculated by Formula 1 or by Formula 2 and the data block number per TTI, the corresponding result can be represented as Table 1.

TABLE 1

| | | m (the number of multi HARQ | | | | | |
|---|---|---|---|---|---|---|---|
| | | processes per packet) | | | | | |
| | | 2 | 3 | 4 | 5 | 10 | 20 |
| p(q) (the | 0.7 | 2.02 | 2.97 | 4.04 | 5.16 | 10.72 | 20.98 |
| probability | 0.8 | 1.72 | 2.46 | 3.36 | 4.37 | 9.93 | 20.77 |
| of success | | | | | | | |
| (fail) trans- | 0.9 | 1.38 | 1.8 | 2.38 | 3.05 | es7.51 | 18.57 |
| mission) | 0.99 | 1.04 | 1.09 | 1.16 | 1.25 | 1.96 | 4.64 |

Referring to Table 1, if transmission success probability p (or, transmission failure probability q) of data block is 0.7 or higher, it can be observed that the bit number for feedback transmission becomes smaller than the number of data blocks transmitted during one TTI. And, it can be also observed that a signaling overhead reducing effect sharply increases in proportion to higher transmission success probability.

In the above description, a method of reducing a signaling overhead by feedback transmission in case of transmitting a plurality of data bocks (multiple HARQ processes) during a transmission time interval in a terminal according to one embodiment of the present invention is explained.

The present invention also provides a method of transmitting a group feedback for one or more data blocks transmitted by a plurality of terminals (MS: mobile stations) during a TTI.

A method for transmitting a group feedback for multiple feedbacks according to another embodiment of the present invention is explained as follows.

Currently, in a current communication system, one base station (BS) may serve a plurality of terminals and multiple uplink feedback process data can be transmitted by a plurality of the terminals during a TTI. In the related art, a base station receives a plurality of uplink data from a plurality of terminals during a TTI and is then able to transmit feedback information corresponding to the plurality of data transmitted from the plurality of the terminals (mobile stations: MS) on a downlink feedback channel corresponding to the TTI.

Yet, in a frame structure having a relatively short TTI, since the number of feedback process data transmittable during one TTI is limited, the probability of error occurrence of the data transmitted during the TTI is not high. For instance, although error due to communication environment may exits, as a result of analyzing a feedback overhead in a general communication system, the probability for a base station to successfully receive all data blocks within a TTI is about 78%. Therefore, in this case, it is able to minimize waste of radio resources by using a group feedback.

For this, according to the present embodiment, when a base station successfully decodes all uplink data blocks transmitted from a plurality of terminals, a method of transmitting a group ACK as broadcasted information is provided.

Moreover, if a base station fails to successfully decode all data blocks transmitted from a plurality of terminals, the base station transmits a group NACK and is able to further transmit ACK/NACK information on each data block transmitted from each terminal via a feedback channel (ACK channel). Therefore, each of the terminals is able to recognize a presence or non-presence of error of data transmitted by itself.

Namely, in order to obtain feedback information on each data block transmitted by each terminal during a specific TTI, the corresponding terminal receives and checks a group feedback field corresponding to the specific TTI. If the group feedback field indicates a group ACK, it is able to omit decoding of a feedback channel (ACK channel). In this case, a base station may not allocate the feedback channel. On the contrary, if the received field indicates a group NACK, the corresponding terminal checks the feedback information on the data transmitted by itself through decoding of the feedback channel and is then able to find out a presence or non-presence of error.

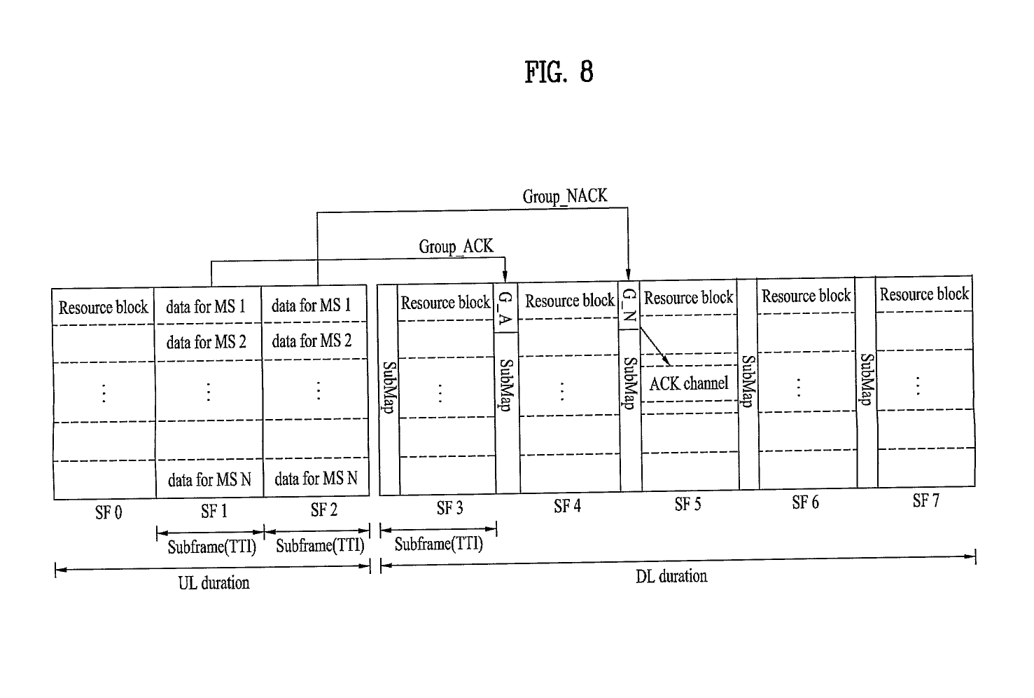

An example of the method of transmitting a group feedback is explained with reference to FIG. 8 as follows.

FIG. 8 is a conceptional diagram of a group feedback according to another embodiment of the present invention.

Referring to FIG. 8, for transmissions of data and group feedback in a wireless communication system, it is able to use a frame structure constructed with eight subframes. In particular, one frame includes three uplink subframes SF0 to SF2 and five downlink subframes SF3 to SF7. And, assume that each of the subframes corresponding to 1 TTI.

One uplink subframe can include a plurality of data blocks. And, one downlink subframe can be constructed with a resource region including a plurality of resource blocks and a sub-map including resource allocation information of the resource region.

Data blocks transmitted during a time amounting to 1 TTI can be transmitted to a base station via one uplink subframe. The base station receives data transmitted via each uplink subframe and is then able to determine whether the received data is erroneous. And, a corresponding feedback can be transmitted via a predetermined downlink subframe.

For instance, referring to FIG. 8, a feedback for data transmitted in the uplink subframe SF1 can be transmitted to each terminal via the downlink subframe SF4. And, a feedback for data transmitted via the uplink subframe SF2 can be transmitted to each terminal via the downlink subframe SF5.

In this case, assume that N data blocks are transmitted via one uplink subframe. And, assume that each of N terminals transmits one data block to a base station. The base station is able to use a method of combining a group feedback indicating a presence or non-presence of error of all data blocks received during 1 TTI and feedback information indicating a presence or non-presence of error of each data block data.

In particular, if all of a plurality of data blocks transmitted from N terminals via the second uplink subframe SF1 to a base station are successfully decoded, the base station is able to transmit a group ACK as a corresponding feedback via the sub-map of the second downlink subframe SF4. Therefore, the base station may not allocate a feedback channel to the subframe SF4 and the terminal may not decode the feedback channel.

On the contrary, if at least one of a plurality of data blocks transmitted to the base station in the third uplink subframe SF2 fails in decoding, the base station is able to transmit a group NACK as a corresponding feedback via a sub-map of the third downlink subframe SF5. Moreover, the base station is able to individually transmit a presence or non-presence of error about each data block transmitted from each terminal on a feedback channel (ACK channel) allocated to a resource region of the third downlink subframe SF5.

Namely, a group feedback (group ACK/NACK) can be broadcasted to each terminal, which has transmitted data blocks, via a group feedback field within a sub-map of a prescribed downlink subframe. In case of a group NACK, feedback information indicating a presence or non-presence of error of each data block can be transmitted via a resource region of the same subframe.

Therefore, in case that the present invention is applied, it is able to reduce a signaling overhead considerably smaller than that of the scheme for transmitting an individual presence or non-presence of error for each terminal entirely on a feedback channel.

FIG. 8 just shows an example of the present embodiment. Each of a plurality of terminals may transmit one or more data block. A position for transmitting a group feedback to each terminal is not limited to a sub-map only but a different channel can be broadcasted to each terminal or a shared channel can be used. Moreover, in case that probability of NACK occurrence in a data block transmitted by a terminal is high according to channel environment, a base station is able to transmit feedback information, which indicates a presence or non-presence of error of each data block, to a terminal in case of group ACK only, which is contrary to the case shown in FIG. 8.

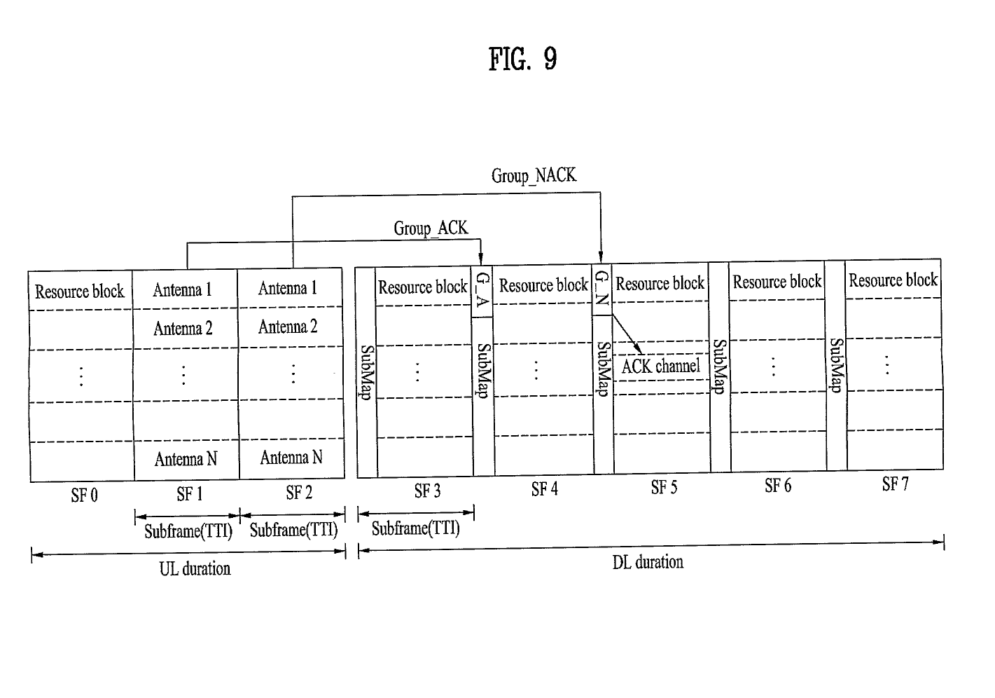

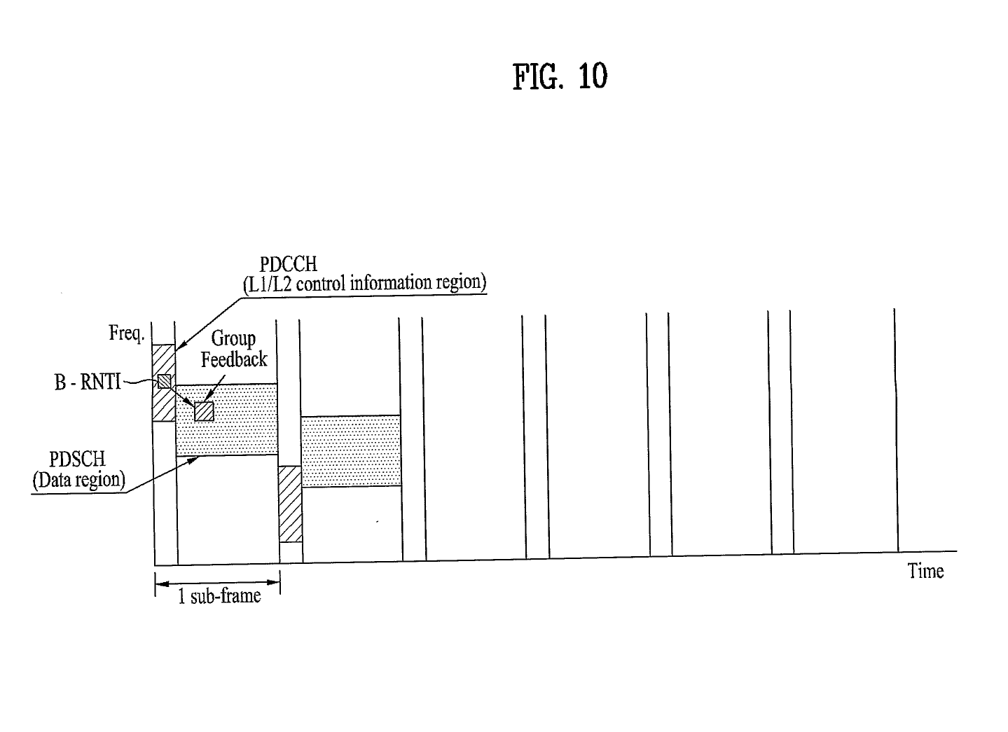

Meanwhile, the present embodiment is applicable to a case of receiving N data blocks, which are transmitted via each antenna of a terminal having N antennas (MCW MIMO: Multiple CodeWord Multiple-Input Multiple-Output) instead of receiving the N data blocks from N terminals, respectively. This is explained with reference to FIG. 9 as follows.

FIG. 9 is a conceptional diagram of a group feedback according to another embodiment of the present invention. For clarity, detailed descriptions of parts overlapped with those shown in FIG. 8 will be omitted in the following description.

Referring to FIG. 9, if each of N antennas of a terminal transmits one data block, the terminal can transmit N data blocks to a base station during 1 TTI. This case, the base station is able to determine a presence or non-presence or error for the whole data blocks received during the corresponding TTI. According to a result of the determination of the presence or non-presence of error, the base station is able to broadcast a group feedback to each of the antennas. If the base station successfully decodes all data blocks transmitted during the corresponding TTI, it is able to broadcast a group ACK to each of the antennas.

On the contrary, if the base station fails to successfully decode all data blocks transmitted from the respective antennas, the base station is able to transmit ACK/NACK information on each terminal via feedback channel (ACK channel) together with a group NACK which may be broadcasted.

In this case, as shown in FIG. 8, the base station may not allocate the feedback channel (ACK channel) in case of transmitting the group ACK. On the contrary, in case of a group NACK, the base station is able to transmit feedback information indicating a presence or non-presence of ACK/NACK per individual antenna via the feedback channel.

In doing so, it is able to broadcast the group feedback (group ACK/NACK) to each antenna having transmitted a data block through the group feedback field within the sub-map. In case of the group NACK, feedback information indicating a presence or non-presence of error for each data block can be transmitted to each antenna via a resource region of the same subframe.

Of course, in case that one antenna transmits one data block, it is just exemplary. And, the present embodiment is non-limited by this case. The terminal is able to partially use a plurality of the antennas. And, the present embodiment is applicable to a case of transmitting a plurality of data blocks via one antenna. And, a position for transmitting a group feedback to each terminal is not limited to a sub-map and a different channel for broadcasted to each terminal or a shared channel is available. Moreover, in case that probability of NACK occurrence in a data block transmitted by each antenna is high according to a channel environment, a base station is able to transmit feedback information, which indicates a presence or non-presence of error of each data block, to each antenna in case of a group ACK only, which is contrary to the case shown in FIG. 9.

According to yet another embodiment of the present invention, it is able to apply a group feedback to a communication system that uses a physical channel structure different from the frame structure explained with reference to FIG. 8. For instance, a case of applying the present invention to the 3GPP LTE (the 3^{rd} Generation Partnership Project Long Term Evolution) is explained with reference to FIG. 10 as follows.

FIG. 10 shows an example of a physical channel structure available for the LTE system.

Referring to FIG. 10, a physical channel is constructed with a plurality of subframes on a time axis and a plurality of subcarriers on a frequency axis. In this case, one subframe is constructed with a plurality of symbols on the time axis. One subframe is constructed with a plurality of resource blocks. One resource block is constructed with a plurality of symbols and a plurality of subcarriers. And, each subframe is able to use specific subcarriers of specific symbols (e.g., first symbol) of a corresponding subframe for PDCCH (Physical Downlink Control CHannel), i.e., L1/L2 control channel. FIG. 10 shows an L1/L2 control information transport region (PDCCH) and a data transport region (PDSCH: Physical Downlink Control CHannel). In the LTE system under ongoing discussion, a radio frame of 10 ms is used. And, one radio frame is constructed with 10 subframes. Moreover, one subframe is constructed with two consecutive slots. A length of one slot is 0.5 ms. One subframe is constructed with a plurality of OFDM symbols. And, it is able to use some (e.g., first symbol) of a plurality of the OFDM symbols to transmit L1/L2 control information. A unit time for transmitting data, i.e., TTI (transmission time interval), is 1 ms.

A base station/terminal generally transmits/receives data on a physical channel PDSCH using a transport channel DL-SCH (Downlink Shared CHannel) except a specific control signal or specific service data. Data of PDSCH is transmitted to a prescribed terminal (one or more terminals). And, information indicating how the terminals receive and decode the PDDSCH data is included in the PDSCH and transmitted to the prescribed terminal.

In case of the LTE, a base station provides control information on data transmitted on PDSCH using PDCCH. In other words, data is transmitted to prescribed terminal(s) via PDSCH, and information indicating how the terminals receive and decode the PDSCH data is transmitted via PDCCH.

In this case, control information is CRC (cyclic redundancy check) masked with a radio network temporary identifier (RNTI) differing according to each usage and is then able to be decoded using blind coding scheme.

For instance, assume that a specific PDCCH is CRC masked with RNTI ‘A’. And, assume that information on data, which is transmitted using a radio resource ‘B’ (e.g., a specific frequency) and transmission format information ‘C’ (e.g., transport block size, modulation scheme, coding information, etc.), is transmitted via specific subframe.

If so, at least one or more terminals in a corresponding cell monitor (blind decode) the PDCCH using RNTI information possessed by themselves. If there is at least one terminal having an RNTI ‘A’, the corresponding terminals receive the PDCCH and then receive a PDSCH indicated by ‘B’ and ‘C’ through information of the received PDCCH. Namely, the PDCCH includes downlink scheduling information on a specific terminal and the PDSCH includes downlink data corresponding to the downlink scheduling information. Moreover, a base station is able to transmit uplink scheduling information on the specific terminal via the PDCCH.

In this case, RNTI includes C-RNTI (Cell-RNTI), PI-RNTI (Paging Indication-RNTI), SC-RNTI (System information Change-RNTI), SI-RNTI (System Information-RNTI) or the like.

To describe a case of applying a group feedback according to the present embodiment in the above-configured radio frame of the LTE system, assume a case that each of a plurality of terminals transmits one data block to a base station during one TTI.

If a base station successfully decodes all uplink data blocks transmitted from a plurality of terminals, the base station is able to transmit a group ACK only as broadcasted information to the terminal. If the base station fails to successfully receive any one of the data blocks transmitted from a plurality of the terminals, the base station is able to transmit a group NACK as broadcasted information and ACK/NACK information on each of the data blocks transmitted by the terminal via PHICH (Physical HARQ Indication CHannel). This group feedback (Group_ACK/NACK) can be broadcasted to the terminal using SI-RNTI, SC-RNTI or PI-RNTI. And, the base station is able to broadcast group feedback information to each terminal via B-RNTI (Broadcast-RNTI). In this case, the B-RNTI is an RNTI proposed by the present invention and means an identifier usable in transmitting broadcasting information except system information.

Accordingly, the base station is able to perform mapping the group feedback information to the B-RNTI. Having received the group feedback (Group_ACK/NACK), the terminal is able to skip the decoding of PHICH in case of a group ACK. On the contrary, in case of receiving a group NACK, the terminal decodes the PHICH and is then able to receive feedback information indicating individual ACK or NACK for the corresponding terminal. Therefore, according to the present embodiment, it is able to enhance overall system performance by reducing decoding and signaling overhead.

Meanwhile, in the above-described embodiments, if data failing in decoding exists in any one of multiple uplink data blocks transmitted during unit time (TTI), a base station transmits a group NACK and all feedback (ACK/NACK) information on each terminal via a feedback channel (ACK channel or PHICH).

Yet, in case that a base station transmits a group NACK, it is highly probable that the number of data blocks generating NACK occurrence among a plurality of data blocks transmitted during 1 TTI is much smaller than that of data blocks generating ACK. Due to this reason, in case of transmitting a group NACK in the present invention, it is able to transmit NACK information on a specific terminal having a NACK occurrence only instead of transmitting ACK/NACK information on all terminals via a feedback channel.

For this, it is able to transmit NACK information on a terminal, which has transmitted a data block having a NACK occurrence, by CRC masking to enable the corresponding terminal to receive the NACK information only. Besides the CRC masking, various indication methods are available for implementation of enabling a corresponding terminal to receive NACK information only.

The present embodiment is applicable to a case that multiple ACK/NACK can occur in one terminal such as a terminal having a plurality of antennas as well as to a case of a plurality of data blocks transmitted by a plurality of terminals.

Thus, if the NACK occurrence amount of a terminal having NACK occurrence is reduced, an effect of the present embodiment can be maximized.

### INDUSTRIAL APPLICABILITY

Accordingly, the embodiments of the present invention are described on the assumption that a transmitting end and a receiving end include a terminal and a base station, respectively. On the contrary, the embodiments of the present invention are also applicable to a case that a transmitting end and a receiving end include a base station and a terminal, respectively.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1.-18. (canceled)

19. A method of receiving a group feedback by a transmitting end in a wireless communication system, the method comprising:
transmitting at least one data unit to a receiving end during a prescribed time interval; and
receiving a group feedback indicating a presence or non-presence of error for the overall at least one data unit from the receiving end.

20. The method of claim 19, wherein the group feedback comprises a group ACK only if the transmitted at least one data unit is errorless overall and wherein the group feedback comprises a group NACK if the transmitted at least one data unit is not errorless overall.

21. The method of claim 20, further comprising the step of if the group feedback comprises the group NACK, receiving feedback information indicating a presence or non-presence of error of each of the at least one data unit from the receiving end.

22. The method of claim 21, wherein the group feedback is broadcasted from the receiving end via a sub-map of a prescribed subframe and wherein the feedback information indicating the presence or non-presence of the error of the each of the at least one data unit is received via a prescribed resource block.

23. The method of claim 21, the group feedback receiving step comprising the step of obtaining control information of the group feedback by blind-coding a control channel transmitted from the receiving end with a radio network temporary identifier (RNTI) for broadcasting information,
wherein the group feedback is obtained via a downlink shared channel using the control information.

24. The method of claim 23, wherein the feedback information indicating the presence or non-presence of the error of the each of the at least one data unit is obtained by decoding a PHICH (Physical HARQ Indication CHannel).

25. The method of claim 23, wherein the radio network temporary identifier (RNTI) for the broadcasting information comprises one of SI-RNTI, SC-RNTI, PI-RNTI and B-RNTI (Broadcast-RNTI) which is used for broadcasting information except system information.

26. The method of claim 19, wherein the transmitting end comprises a terminal having multiple antennas and wherein the at least one data unit is transmitted via at least one of the multiple antennas of the terminal.

27. A method of transmitting a group feedback by a receiving end in a wireless communication system, the method comprising:
receiving a plurality of data units from a transmitting end during a prescribed time interval;
detecting errors for each of a plurality of the received data units, respectively; and
transmitting a group feedback indicating a presence or non-presence of error for a plurality of the overall data units to the transmitting end according to a result of the error detecting step.

28. The method of claim 27, wherein the group feedback comprises a group ACK only if the received data units are errorless overall and wherein the group feedback comprises a group NACK if the received data units are not errorless overall.

29. The method of claim 28, wherein if the group feedback comprises the group ACK, the receiving end does not transmit feedback information on each of a plurality of the data units.

30. The method of claim 28, the group feedback transmitting step comprising the step of if the group feedback comprises the group NACK, transmitting feedback information indicating a presence or non-presence of error of each of a plurality of the data units to the transmitting end.

31. The method of claim 30, wherein the transmitting end comprises a plurality of terminals, wherein at least one of a plurality of the data blocks is transmitted by each of a plurality of the terminals, and wherein the feedback information is only transmitted to the terminal having an error in a data unit among a plurality of the terminals.

32. The method of claim 30, wherein the group feedback is broadcasted to the transmitting end via a sub-map of a prescribed subframe and wherein the feedback information is transmitted via a prescribed resource block within the subframe carrying the group feedback.

33. The method of claim 32, the group feedback transmitting step comprising the steps of:
CRC masking control information of the group feedback with a radio network temporary identifier (RNTI) for broadcasting information; and
transmitting the control information to the transmitting end on a control channel.

34. The method of claim 33, wherein the radio network temporary identifier (RNTI) for the broadcasting information comprises one of SI-RNTI, SC-RNTI, PI-RNTI and B-RNTI (Broadcast-RNTI) which is used for broadcasting information except system information.

35. The method of claim 31, wherein the feedback information is CRC masked with a prescribed radio network temporary identifier (RNTI) value for the terminal having error in the data unit.

36. The method of claim 27, wherein the transmitting end comprises a terminal having multiple antennas and wherein a plurality of the data units are transmitted via at least one of the multiple antennas of the terminal.

37. The method of claim 31, wherein the group feedback is broadcasted to the transmitting end via a sub-map of a prescribed subframe and wherein the feedback information is transmitted via a prescribed resource block within the subframe carrying the group feedback.

38. The method of claim 37, the group feedback transmitting step comprising the steps of:
CRC masking control information of the group feedback with a radio network temporary identifier (RNTI) for broadcasting information; and
transmitting the control information to the transmitting end on a control channel,
wherein the radio network temporary identifier (RNTI) for the broadcasting information comprises one of SI-RNTI, SC-RNTI, PI-RNTI and B-RNTI (Broadcast-RNTI) which is used for broadcasting information except system information.
